(19) United States
(12) Patent Application Publication
(10) Pub. No.: US 2006/0182550 A1
(43) Pub. Date: Aug. 17, 2006

(54) Loading and unloading stand for palletless storage system

(76) Inventor: Wan Young Lee, Seoul (KR)

Correspondence Address: SHERIDAN ROSS PC, 1560 BROADWAY, SUITE 1200, DENVER, CO, 80202, US

(21) Appl. No.: 10/562,184

(22) PCT Filed: Jun. 29, 2005
(86) PCT No.: PCT/KR05/02036

§ 371 Date: Dec. 22, 2005

(30) Foreign Application Priority Data
Jul. 6, 2004 (KR) 10-2004-0052327

(51) Int. Cl. B65G 65/00

(52) U.S. Cl. 414/277

(57) ABSTRACT

The loading and unloading stand a palletless rack type storage system has plural fork bars, longitudinal beam arranged in a right angle for supporting the fork bar, plural rollers being arranged in the fork bar and the upper portion of the roller having an excessive protrusion above the top of the fork bar so as to allow wheels of the cargo to be rolling-contacted, and a drive unit to keep the rollers rolling in the loading or unloading direction of the cargo, in which the loading/unloading stand providing at a rim near the entrance of an predetermined floor of the rack and being a same level as the loading and unloading conveyor to load cargo into the rack from a loading station, or unload cargo to an unloading station from the rack. The cargo can be smoothly and conveniently be transferred between the conveyor and the stacker crane without using special loading/unloading means.

### TECHNICAL FIELD

The present invention relates to a loading and unloading stand for palletless storage system, by which cargo can park on a loading rack in an automatic loading/unloading means without using a pallet, and more specifically to the loading and unloading stand for palletless storage system, in which the stand is placed in a storage space of a rack for loading/unloading the cargo, by which the cargo can be loaded into or unloaded from the rack along the automatic loading/unloading transfer means installed at the outer station, and so the cargo can be smoothly and conveniently be transferred between two stations without using special loading/unloading means.

### BACKGROUND ART

Generally, a cargo storage system is a storage means to keep and manage efficiently a lot of cargo in a minimal space, and the system is widely used in a grand scale logistic system, or a warehouse of various industrial supplies.

The cargo storage system is normally comprised of plural stands installed at a rack in a lattice form and at a regular interval and loading/unloading means such as a lift or stacker crane for transferring the cargo through a passage between each rack. Individual code, for instance, is assigned to both the cargo and the stand, and a control computer can control the loading/unloading means to load and unload a cargo in an automatic manner.

At the same time, an automatic loading/unloading transfer means having a conveyor is provided at an entrance/exit. At an unloading station, the cargo transferred by a fork lifter is moved to an entrance/exit of each rack, or the cargo retreated from the rack is moved to the unloading station. Thus, the fully automatic loading/unloading process can be performed.

The cargo storage system is classified into a pallet type system or a palletless type system in accordance with the loading/unloading method of a cargo.

The pallet type cargo storage system is a method to load/unload the cargo placed on a separate pallet, which constitutes a main current. The cargo arrives at an entrance of a rack along a loading/unloading conveyor, and a transfer means approaches the outside of the rack to lift the pallet placed on the conveyor using the transfer means' fork. The pallet having cargo is conveyed an empty stand of the rack. The unloading process is achieved in the reverse order.

In the pallet type cargo storage system, a separate pallet is required for providing a lowering space for the fork of the transfer means to lift/lower the cargo.

This causes a problem of complexity to the loading process and also of heavy loading of the cargo.

On the other hand, the palletless type cargo storage system is known as the method to load/unload the cargo directly without using a pallet, which is disclosed in Japanese Patent Laid-open Publication No. Heisei 8-120964, and Utility Model Laid-open Publication No. Heisei 5-85953, and Korean Patent Publication No. 0418328.

In the palletless type cargo system, a stand of a rack and a fork of a transfer means are comprised of plural parallel bars alternatively overlapped, by which cargo can be loaded/unloaded to/from each other. Thus, the transfer means can not take the cargo place on the conveyor directly, or the cargo unloaded from the stand can not be transferred to the conveyor. In this case, a separate means for loading/unloading the cargo must be provided between the conveyor and the specific stand.

As shown in Japanese Patent Laid-open Publication No. Heisei 8-120964, and Utility Model Laid-open Publication No. Heisei 5-85953, if a car (or a cargo) can move by itself, there is no specific problem in that the cargo can approach the specific stand of a rack or retreat from the stand.

With this reason, the palletless type cargo storage system has mainly been used in parking systems. In the case of only cargo storage system, a separated loading/unloading means must be required as illustrated above. That causes a problem in that the loading/unloading process has complexity, and also, the much process time is needed.

### DISCLOSURE OF THE INVENTION

Accordingly, the present invention has been made with taking the above problems occurring in the prior art into consideration, and an object of the present invention is to provide a loading and unloading stand for palletless storage system installed in the rack, in which cargo can approach the rack along on the conveyor, the cargo is loaded on the rack, or is unloaded from the rack to the conveyor, even if no extra loading/unloading means, the transfer means such as the stacker crane can load/unload the cargo quickly and conveniently.

In order to accomplish the above object, in a loading and unloading stand of a palletless rack type storage system comprised of a plurality of racks having a loading fork and a stacker crane for loading cargo onto or unloading from the rack, and the stacker crane having a transfer fork arranged in a right angel to the loading fork, the transfer fork moving up or down in respect to the loading fork, the loading and unloading stand is comprising of plural fork bars arranged lengthwise with an interval to each other;

longitudinal beam arranged in a right angle against the fork bar, and supporting below the fork bar, so that at least one free end of the fork bar takes a form of cantilever, and fixedly mounting each fork bar on the rack;

plural rollers being arranged in a proper interval in the fork bar and the roller's rotation center arranged along a width of the fork bar, the upper portion of the roller having an excessive protrusion above the top of the fork bar so as to allow wheels of the cargo to be rolling-contacted; and

a drive unit to keep the rollers rolling in the loading or unloading direction of the cargo, in which the loading/unloading stand providing at a rim near the entrance of an predetermined floor of the rack and being a same level as the loading and unloading conveyor to load cargo into the rack from a loading station, or unload cargo to an unloading station from the rack.

In accordance with a preferred feature of this invention, the longitudinal beam is comprised of a first longitudinal beam for supporting one end of the fork bar and a second longitudinal beam for supporting middle portion of the fork bar, in which the transfer fork approaches toward only one lateral side of the stand. Otherwise, each longitudinal beam support each end of the fork bar, where the respective supporting point is a distance from each end of the fork bar toward the middle of the fork bar, and the respective ends of each longitudinal beam are connected with a post, the transfer beam approaches both lateral sides of the stand.

According to necessity, a projection tab is provided at the lower middle portion of the fork bar with a proper height and is connected with each longitudinal beam, which makes clearance to allow the transfer fork of the stacker crane to move above the longitudinal beam.

In accordance with a preferred feature of this invention, the stand is further comprised of a stopper such as a limit switch or a distance sensor, by which the cargo running on the fork bar stops at a predetermined position.

In accordance with further preferred feature of this invention, the stand is further comprised of a weight sensor that is installed at the lower portion of the longitudinal beam, by which the deflection of the longitudinal beam caused by the overweight cargo is measured, and a denial signal for overweight cargo is generated.

According to the present invention, a loading and unloading stand for palletless storage system, cargo can approach the rack along on the conveyor, not on a pallet. The cargo is smoothly transferred on the stand installed in the rack. On the other hand, the cargo to be unloaded from the rack, smoothly moves to the conveyor after the cargo is transferred on the stand. Thus, even if no extra loading/unloading means, the transfer fork of the stacker crane can load/unload the cargo quickly and conveniently.

Therefore, the present invention has an advantage, in quick and precise loading or unloading of cargo into or from storage spaces, which can be accomplished and the operational reliability can be improved, considerably.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a palletless storage system having a loading and unloading stand according to a present invention;

FIG. 2 is a plan view taken along line II-II of FIG. 1;

FIG. 3 is a plan view schematically showing a loading and unloading stand for palletless storage system;

FIG. 4 is a cross-sectional view taken along line IV-IV of FIG. 3;

FIG. 5 is a side view of taken from a point “V” of FIG. 3;

FIG. 6 is an exploded perspective view of a fork bar of a loading and unloading stand;

FIG. 7 is a partial cross-sectional view of a fork bar assembly of FIG. 6; 10 FIG. 8 is a side view taken from VIII of FIG. 7;

FIGS. 9 to 12 are side views showing various embodiments of a fork bar of a loading and unloading stand according to the present invention;

FIGS. 13 and 14 are a plan and a side view showing another embodiment of a fork bar of a loading and unloading stand, respectively;

FIGS. 15 and 16 are a side and a front view showing another embodiment of a fork bar of a loading and unloading stand, respectively;

FIGS. 17 and 18 are a plan and a cross-sectional side view showing further, another embodiment of a fork bar of a loading and unloading stand, respectively;

FIG. 19 is a side view illustrating a working structure of a roller of a fork bar; and

FIGS. 20 to 24 are views sequentially showing working status of a loading and unloading stand of a palletless storage system.

### BEST MODE FOR CARRYING OUT THE INVENTION

This invention will be described in further detail by way of exemplary embodiments with reference to the accompanying drawings.

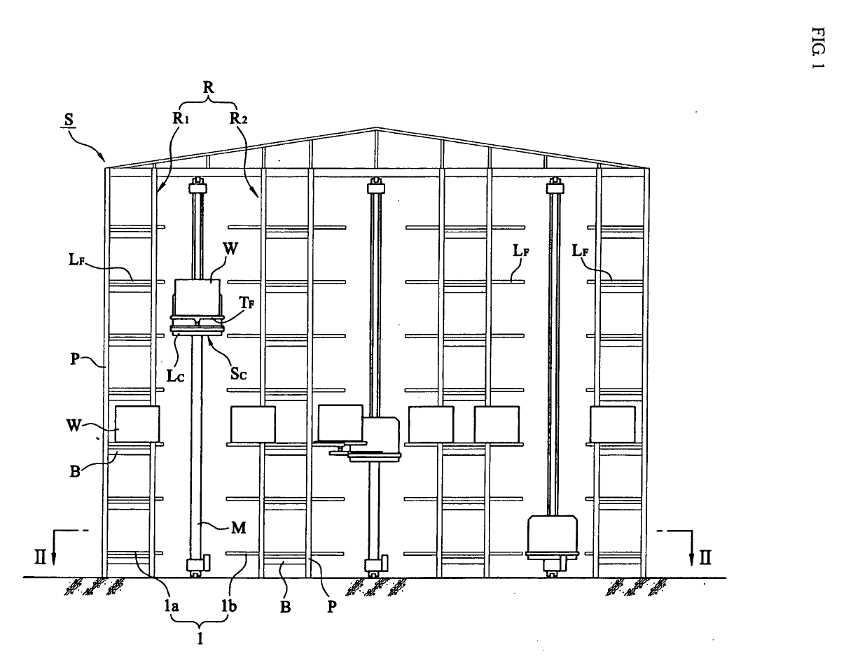

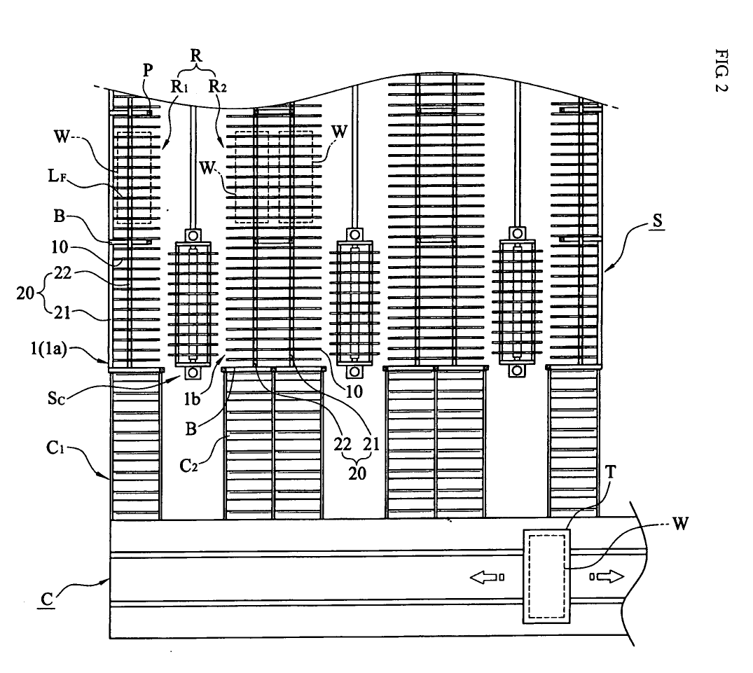

Referring to FIGS. 1 and 2, a palletless rack type storage system S, provided with a loading and unloading stand according to a present invention, is comprised with a plurality of racks R longitudinally arranged in a lattice form and each having a loading fork L_{F} on each storage space and a stacker crane S_{C} provided between two adjoining racks R for moving in a three axis direction, the stacker crane S_{C} having a transfer fork T_{F} which moving toward, up, down, or retracting from the side of the loading fork L_{F}, and the stacker crane S_{C} for loading/unloading cargo W to/from the loading fork L_{F}.

The automatic loading and unloading conveyor C is further provided at an entrance/exit of the palletless rack type storage system S, by which the cargo W can be loaded into the rack R from a loading station, or unloaded to an unloading station from the rack R. The loading and unloading conveyor C has plural loading and unloading conveyors C₁, C₂ which are arranged at the entrance of each rack R in an sequential manner in respect to the rack R.

The inventive loading and unloading stand 1 of the palletless rack type storage system is preferably provided at a predetermined storage space of the rack R, e.g. at the rim near the entrance of the first floor of the rack R and with a same level as the loading and unloading conveyor C.

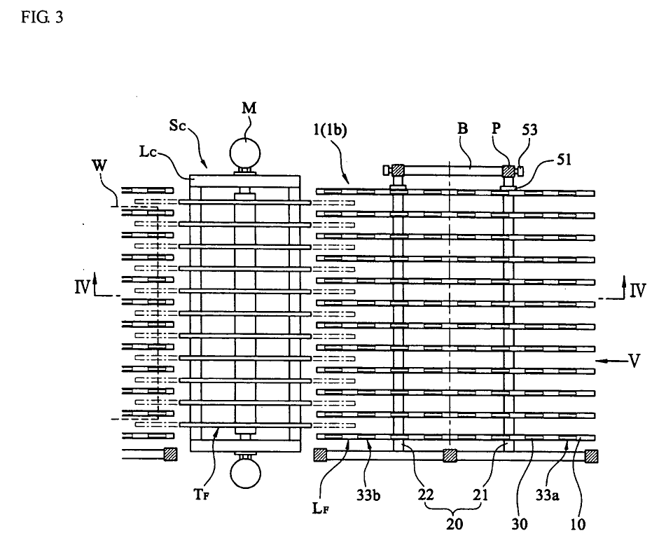

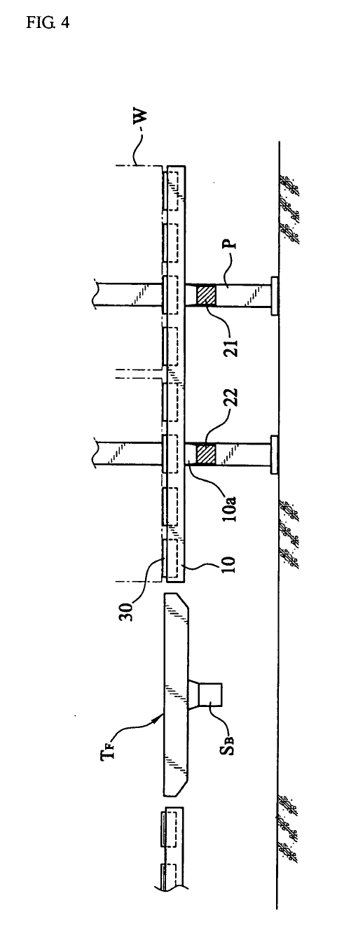

The loading and unloading stand 1, as shown in FIGS. 3 to 5, is comprised of a plurality of fork bars 10 arranged lengthwise with a predetermined interval to each other, a longitudinal beam 20 arranged in a right angle to the fork bar 10 for fixedly mounting each fork bar 10 on the rack R, a plurality of rollers 30 rotationally mounted in each fork bar 10 with a partly exposed upper portion, and a drive unit 50 to keep the rollers 30 rolling in the loading or unloading direction of the cargo W.

The diverse configurations of the fork bar 10 can be employed considering the structural stability of the fork bar and also the mounting way of the roller 30.

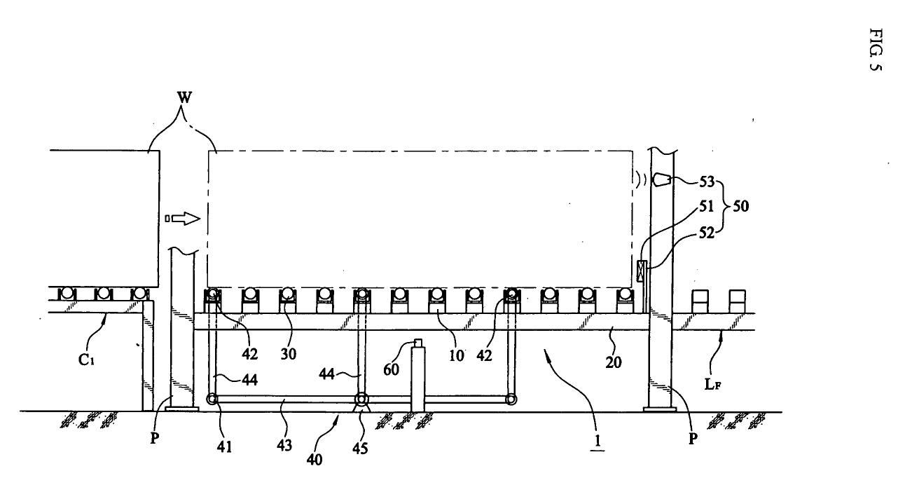

As shown in FIGS. 6 to 8, the fork bar 10 has approximate U shape body 11 and plural support plates 12 placed between each longitudinal wall 11a of the body 11 for rotationally supporting the roller 30. A support hole 12a is provided at each support plate 12 through which a shaft 31 of the roller 30 is rotationally assembled.

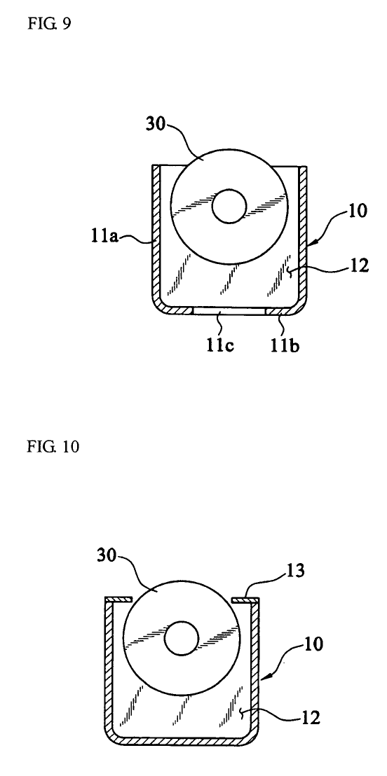

However, since the fork bar 10 has a top open body 11, foreign material can be stacked on the inner floor of the fork bar 10 after long-time use, resulting the interference with the rotation of the roller 30. Therefore, various prevention means for foreign substance accumulation can be configured as shown in FIGS. 9 to 11.

A foreign substance outlet 11c is provided at a floor 11b of the U shape body 11 as shown FIG. 9, or the top opening of the body 11 is covered with a cover 13 so that the upper part of the roller 30 is partially exposed as shown in FIG. 10.

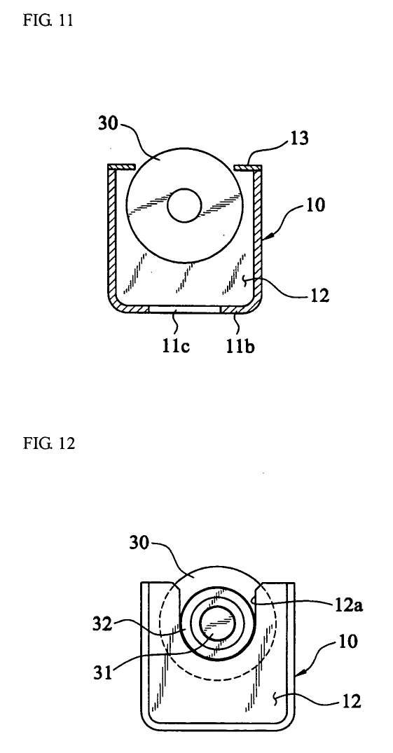

Furthermore, as shown in FIG. 11, the foreign substance outlet 11c is provided at the floor 11b of the body 11, and at a same time the cover 13 is provided at the upper opening of the body 11.

Since the roller 30 will be worn by long-time use, the roller 30 must be taken out from the fork bar 10 to be maintained or replaced. To get easy access to the roller 30, as shown in FIG. 12, an upper portion of the support hole 12a formed at the support plate 12 is left open. That is, the support hole 12a is configured with a U shape.

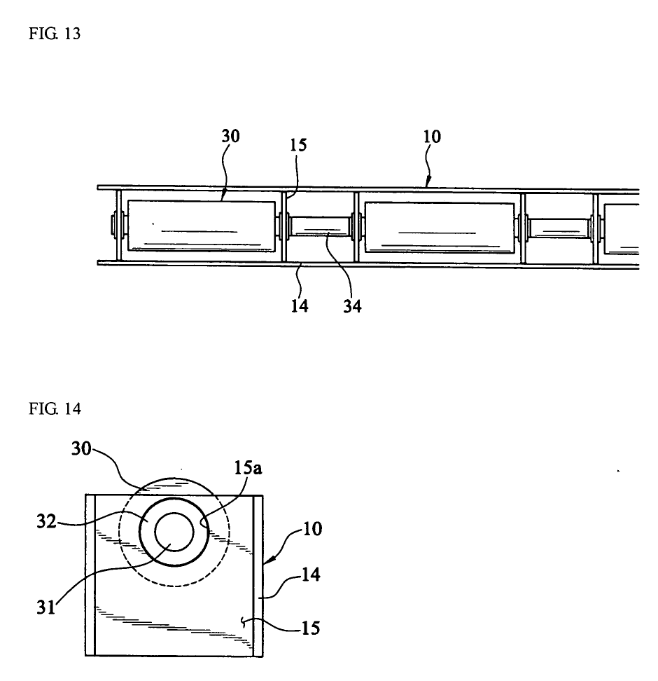

Another embodiment of the fork bar 10 shows in FIGS. 13 and 14. The fork bar 10 is comprised of two parallel longitudinal walls 14 and plural support plates 15 placed at a right angle between each longitudinal wall 14 for rotationally supporting the roller 30.

Since the above fork bar 10 has a top and bottom open shape so that there is no way to accumulate foreign substances, it is not necessary to provide individual means for preventing the accumulation of foreign substances. Furthermore, no separate view is provided but it is possible that the upper portion of the support hole 15a formed at the support plate 15, as shown in FIG. 12, is left open to easily get separation of the roller 30 from the support hole 15a.

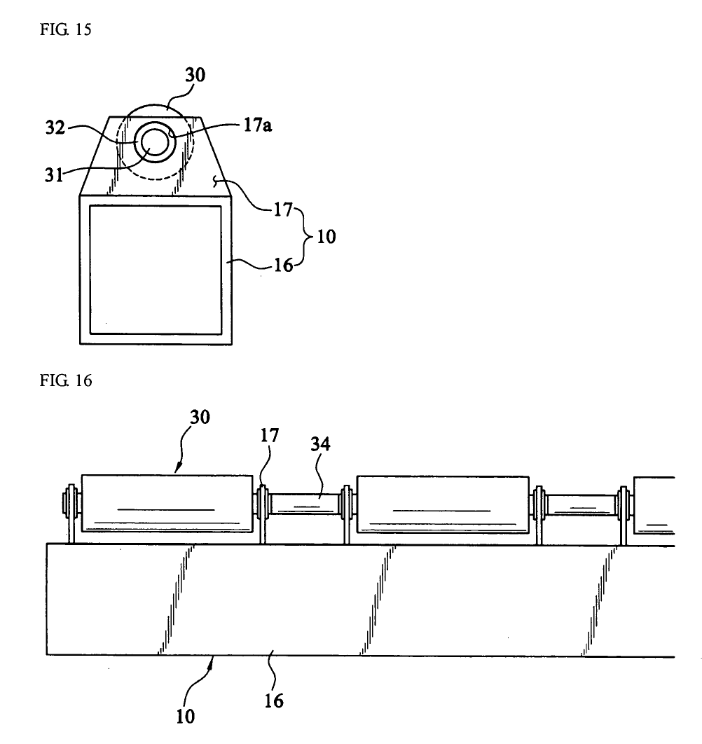

FIGS. 15 and 16 show another embodiment of the fork bar 10. A body 16 of the fork bar 10 is a rectangular shape, and a support plate 17 is uprightly placed on top plate of the body 16 for supporting the roller 30.

No separate view is provided similar to the previous embodiment, but it also could consider that the upper portion of the support hole 17a formed at the support plate 17, as shown in FIG. 12, is left open to easily get separation of the roller 30 from the support hole 17a.

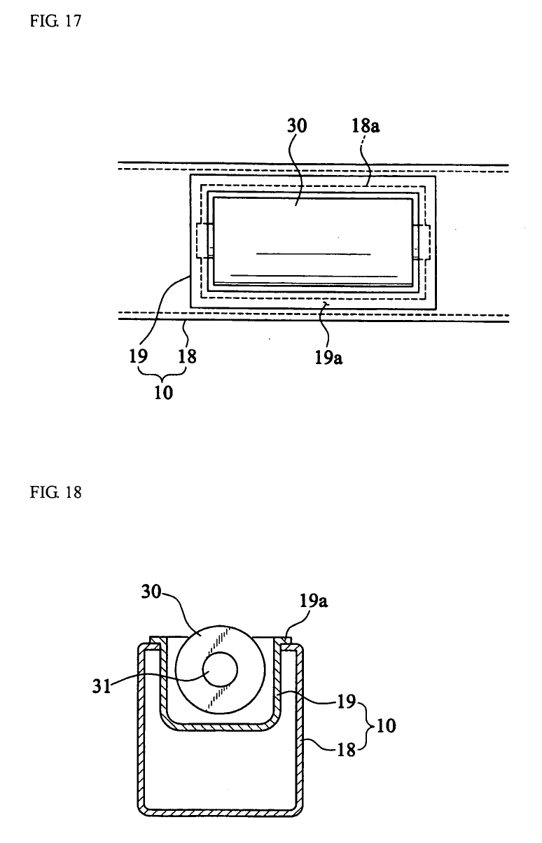

Further embodiment of the fork bar 10 is shown in FIGS. 17 and 18. The embodiment is comprised of a rectangular body 18 having a body opening 18a at the top plate of the body 18, and a container-shape roller housing 19 for accommodating the roller 30.

The roller housing 19 has an outward extended flange 19a at the open top plate, and is fitted in the body opening 18a. The upper part of the roller 30 is partially exposed above the roller housing 19. The embodiment above acquires higher strength of the fork bar 10, and the roller 30 is easy to disassemble.

As shown in FIGS. 1 to 4, fixing location of the longitudinal beam 20 to the fork bar 10 should vary depending on whether the stand 1 is installed at the edge rack R₁ or at the middle rack R₂.

In the edge rack R₁, the longitudinal beam 20 is comprised of a first longitudinal beam 21 supporting one end of the fork bar 10 and a second longitudinal beam 22 supporting middle portion of the fork bar 10. Since the transfer fork T_{F} of the stacker crane S_{C} can approach toward only one lateral side of the edge stand 1a so that the cargo W can be loaded in single row, the other end of the fork bar should take a cantilever beam form.

On the other hand, in the middle rack R₂, the transfer fork T_{F} of the stacker crane S_{C} can approach both lateral sides of the middle stand 1b so that the cargo W can be loaded in two rows. The length of the fork bar 10 of the middle rack R₂ is twice as long as that of the fork bar 10 of the edge rack R₁. The first and second longitudinal beam 21, 22 support each end of the fork bar 10, where the respective supporting point is a distance from each end of the fork bar 10 toward the middle of the fork bar 10. Thus, each free end of the fork bar 10 has a cantilever beam form.

Herein, the respective ends of each longitudinal beam 21, 22 are connected with a post P, and a traverse beam B placed between two adjacent posts P, respectively. Each longitudinal beam 21, 22 can be substituted as a longer side beam of the rack R.

Each first and second longitudinal beam 21, 22 is positioned to offset toward a direction opposite to a transfer passage from the middle portion of the cargo storage space so as to achieve full access of the transfer fork T_{F}. The eccentric amount of the longitudinal beam corresponds to a width S_{B} of the transfer fork T_{F}. The longitudinal beam 20 of the stand 1 is positioned toward the transfer passage as much as possible, so that it increases the safe-ability to the stand 1.

Since the second longitudinal beam 22 installed at the edge rack R₁ as well as the first and the second longitudinal beam 21, 22 installed at the middle rack R₂ support the bottom middle portion of the fork bar 10, when the transfer fork T_{F} of the stacker crane S_{C} approaches toward and retreats from the fork bar 10, or moves up/down, operating clearance is necessary at a place between the transfer fork T_{F} and the fork bar 10 so interference does not occur.

The clearance can be secured by a projection tab provided at the lower middle portion of the fork bar 10 of the transfer fork T_{F} with a proper height. Otherwise, the projection tab 10a can be provided at the lower portion of the fork bar 10 of the stand 1. Alternatively, the projection tab can be installed both the fork bars 10.

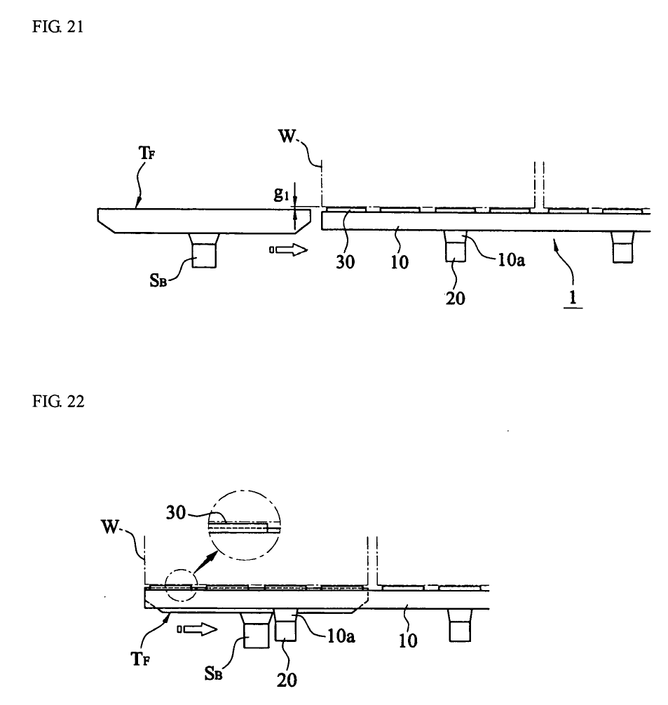

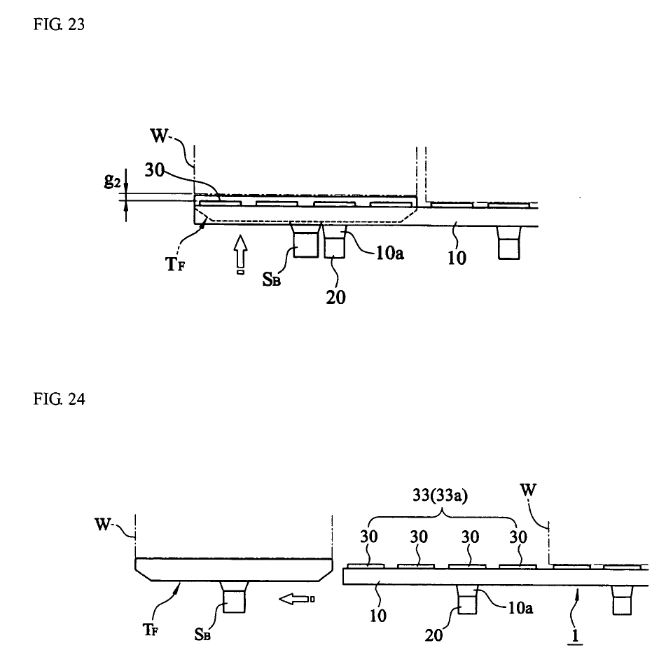

As shown in FIGS. 21 and 23, a height of the projection tab 10a is determined to be at least larger than the upright height of the transfer fork T_{F}, that is, it is larger than the sum of the clearance g₁, g₂ to avoid any interface with the cargo W, when the transfer fork T_{F} of the stand 1 laterally approaches toward or withdraw from the fork bar 10.

Furthermore, no detail is shown but only one longitudinal beam can provide and fix on the rack to support one end of the fork bar, which takes a cantilever beam form.

In the stand 1, for instance, the assembly structure between the fork bar 10 and the longitudinal beam 20 follows the structure of the loading fork L_{F} of the rack R. The inventive palletless storage system S is similar to Korean Patent Publication No. 0418328 that has already been applied by the applicant, in which the transfer fork T_{F} has similar structure as the inventive stand 1 except the roller 30 and the drive unit 40.

As shown in FIGS. 6, 13, 14, 15 and 16, the roller 30 has a bearing 32 at its shaft 31, and the bearing 32 is fitted at each support hole 12a, 15a, 17a formed at each support plate 12, 15, 17. Thus, the roller 30 is rotationally supported in the fork bar 10.

The roller 30 can have a long shape, which each roller, has provided in each fork bar 10. Otherwise, as shown in figures, the roller 30 has short length, and each short roller is arranged at a regular interval with its rotation center being in parallel with lateral direction of the fork bar 10.

The single long roller, roller 30, is installed at the stand 1a of the edge rack R₁. When the roller 30 is installed at the stand 1b of the middle rack R₂, the cargo W must be loaded in two rows. Thus, at least two rollers 30 are provided at single fork bar 10 bordering the middle of the fork bar 10.

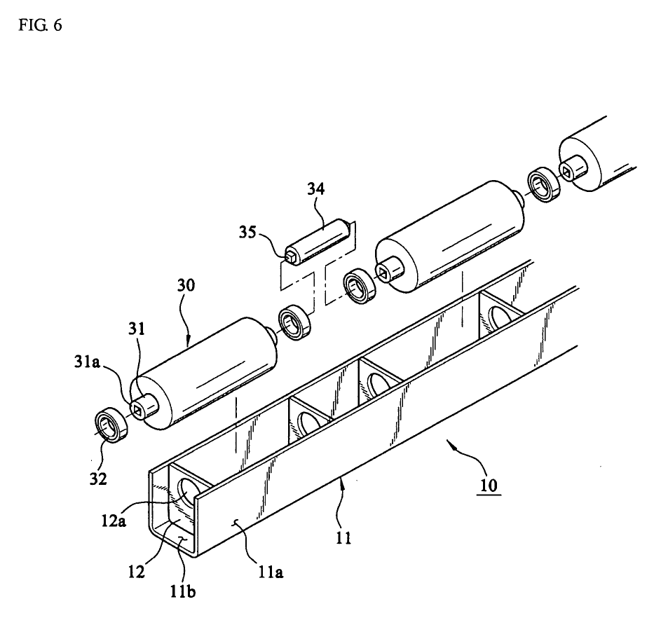

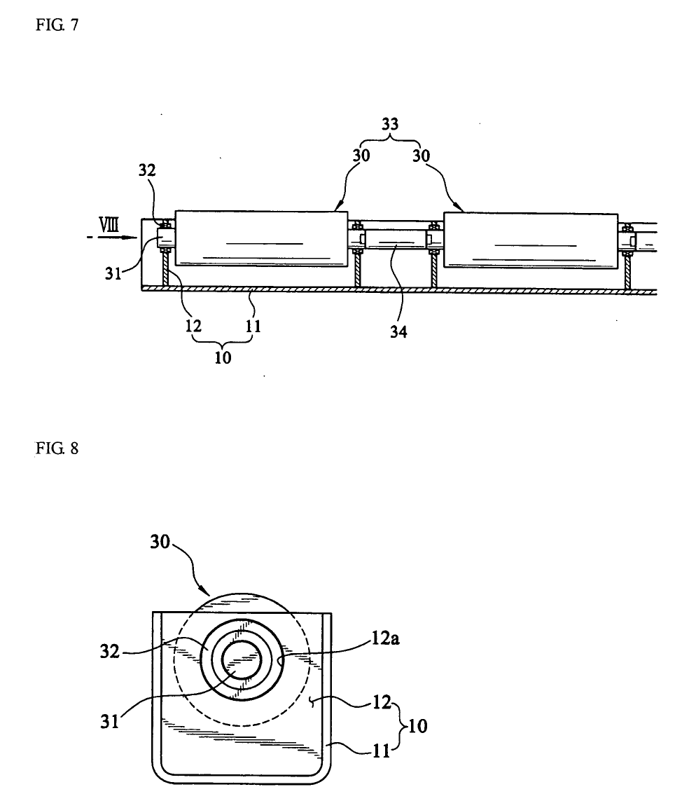

In roller row 33 which is comprised with multiple rollers 30 arranged at each fork bar 10 at a regular interval, as shown in FIGS. 6 and 7, neighboring shaft 31 of each roller 30 is drivingly coupled so that rollers 30 of the each roller row 33 can rotate simultaneously.

As one method of coupling the roller 30, each shaft 31 can be extended and directly connected to each end of shaft 31 using key or keyway that are formed in each shaft 31. Otherwise, as shown in figures, an additional shaft 34 having key 35 at each end of the shaft 34 is placed between neighboring roller 30, and a keyway 31a is formed at the shaft 31 so that the intermediate shaft 34 can be connected with each shaft 31.

In the middle stand 1b installed at the middle rack R₂, first and second roller row 33a, 33b are bordered at the center of the fork bar 10 as shown in FIG. 3. Each roller row 33a, 33b is isolated from each other. That is, the rollers 30, each of which is comprised of the first and second roller row 33a, 33b, is drivingly coupled, but each roller row 33a, 33b does not connect with each other to be rotated.

The drive unit 40 can rotate the entire rollers 30 provided at each fork bar 10 simultaneously. However, since the cargo W has some size, it is preferable that a part of the rollers 30—arranged along a direction of loading/unloading of the cargo W in a certain interval—is connected to the drive unit 40 so it can rotate the roller 30. Furthermore, in the case of the fork bar 10 having the roller row 33 as shown in FIG. 7, the roller 30 of the roller row 33 can not be coupled with each other, but only rollers 30 that act as driving rollers can be drivingly connected.

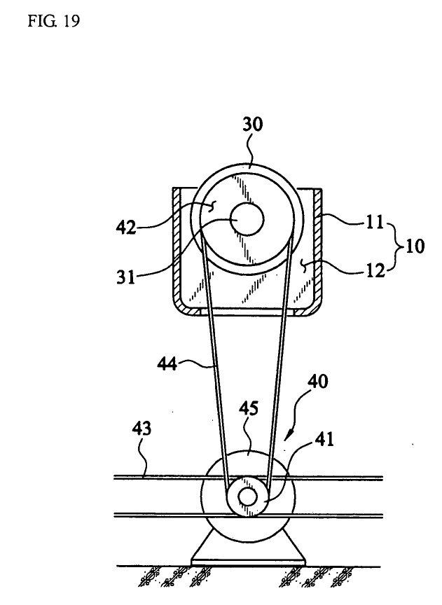

The drive unit 40 can employ diverse configurations. For instance, as shown in FIGS. 5 and 19, the drive unit 40 is comprised of a drive pulley 41 arranged in a predetermined interval below the fork bar 10 having the roller 30 or the roller row 33, a driven pulley 42 provided at a shaft of the roller 30, a first drive belt 43 coupling with neighboring drive pulley 41, a second drive belt 44 connecting with the corresponding drive pulley 41 and driven pulley 42, and a motor 45 for giving rotation to one of any drive pulleys 41.

The drive pulley 41 is comprised of a pulley group having two pulleys 41 so as to transmit the rotation of the motor 45 to the roller 30 or the roller row 33. Further, three pulleys are provided at the shaft of the drive pulley 41 coupling directly with the motor 41.

The driven pulley 42 is installed at the shaft 31 of any one roller 30 or at the shaft 34 connecting with neighboring roller 30 as shown in FIG. 7.

The second drive belt 44 is arranged in a vertical manner so that any interface with the transfer fork T_{F} of the stacker crane S_{C} can be avoided when the transfer fork T_{F} approaches toward or retracts from the stand 1.

Furthermore, a stopper 50, as shown in FIG. 5, is provided at the longitudinal beam 20 between the stand 1 and the post P installed near the loading fork L_{F} so as to stop the cargo W at a predetermined position. The stopper 50 may 1 5 take various configurations. The stopper 50, for instance, has such a configuration that it merely contacts one vertical surface of the cargo W and prevents the further access of the cargo W into the post P. Otherwise, it is desirable that the stopper 50 takes a function that the motor 45 of the drive unit 40 stops when the cargo W has arrived a predetermined position.

To perform the function, the stopper 50 has a limit switch 51 that is attached on a supporter 52 between the cargo W and the post P and the supporter 52 being uprighted from the longitudinal beam 20, by which the motor 45 stops when the cargo W has in contact with the limit switch 51.

As other configuration of the stopper 50, a distance sensor 53 can be employed, by which the distance of the approaching cargo W is detected to stop the motor 45. The distance sensor 53 can be installed on the longitudinal beam 20, but it is more desirable that the distance sensor 53 is installed on the post P of the rack R.

Furthermore, to get accurate and safe limitation of the cargo's access, the limit switch 51 as well as the distance sensor 53 can be employed.

In the case that the cargo W has excessive weight, the rack R may have structural instability. Thus, it has necessary to limit weight below predetermined load in consideration for safety of the rack R.

Being free from fault, the inventive stand 1 further has a weight sensor 60 that is installed at the lower portion of the longitudinal beam 20, by which the deflection of the longitudinal beam 20 caused by the overweight cargo W can be measured. If the measured value is higher that the set value of the deflection, a denial signal for the cargo loading process is generated.

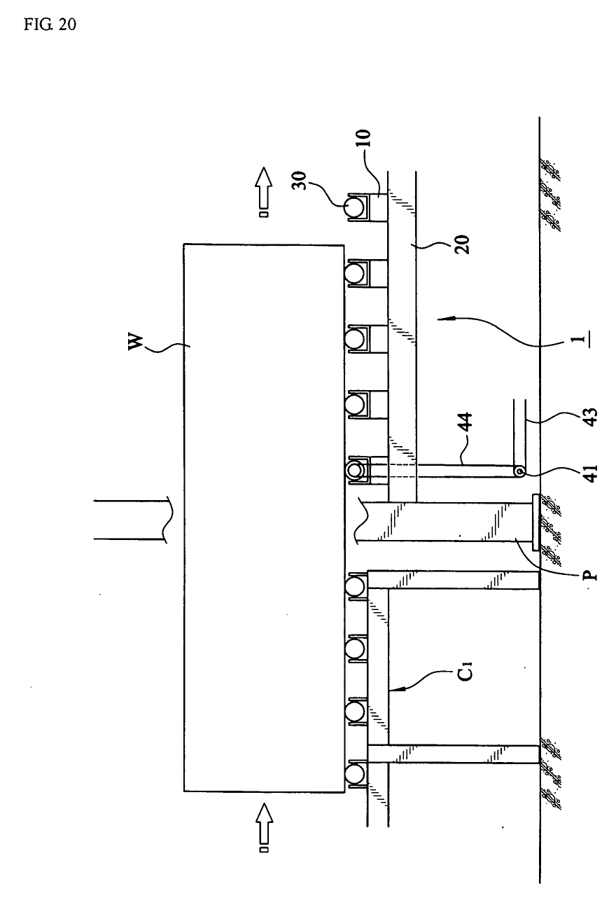

The denial signal is so configured that an electrical signal is sent to a central computer (not shown) controlling the palletless storage system S, and under a command of the central computer the cargo W is immediately unloaded by skipping the loading fork L_{F}. The operation of the palletless rack type storage system, provided with a loading and unloading stand according to the present invention will be described herein below with reference to FIGS. 20 to 24.

Firstly, when in the loading process of the cargo W, at a loading/unloading station the cargo W is transferred to the conveyor C by a fork lifter (not shown) as shown in FIG. 2. The truck T of the conveyor C carries the cargo W to the loading conveyor C₁.

The cargo W moves on the conveyor C₁ towards the rack R. Since the conveyor C₁ is arranged with the rack R in a sequential manner, the cargo W, as shown in FIG. 20, smoothly enters into the stand 1 installed at the rim of the rack R.

The stand 1 is at an even level with the conveyor C₁, and the rollers 30 projected upright above each fork bar 10 are in contact with the bottom of the cargo W. Thus, the cargo W can smoothly move towards the stand 1 from the loading conveyor C₁.

Simultaneously, the rollers installed at each fork bar or some rollers 30 distanced from each other are rotated in a loading direction by the drive unit 40. The cargo W keeps moving towards the stand 1, and finally the cargo W is completely transferred on the stand 1 of the rack R.

After the cargo W has arrived at the predetermined point of the stand 1, the stopper 50 installed between the cargo W and the post P interrupts the working of the motor 45 so that the movement of the cargo W stops completely.

In other words, the cargo W runs on the roller 30 of the stand 1 and is fully loaded. The cargo W is in contact with the limit switch 51 that is attached on a supporter 52 between the cargo W and the post P. Otherwise, the cargo W has arrived at the predetermined distance, and the distance sensor 53 detects it and the motor 45 stops. The rotation of the roller 30 of the fork bar 10 completely stops, which induces the stop of the movement of the cargo W.

The weight sensor 60 that is installed at the lower portion of the longitudinal beam 20 can measure the deflection of the longitudinal beam 20 caused by the overweight cargo W. If the measured value is higher that the set value of the deflection, a denial signal for the cargo loading process is generated from the central computer.

The cargo W denied caused by the overload will not transfer to the load fork L_{F} of the rack R by the stacker carne S_{C}, but is unloaded to the unloading conveyor C₂ right away.

Once the designated weight signal is transmitted from the weight sensor 60, the central computer determines the weight of the cargo W as the acceptable load, and makes the stacker crane SC ready to activate. After that, the stand-by stacker crane S_{C} start to activate as shown in 21. The transfer fork T_{F}, as shown in FIGS. 3 and 22, moves horizontally into the stand 1.

The transfer fork T_{F} enters into the fork bar 10 of the stand 1 in an alternatively overlap manner, but the movement of the transfer fork T_{F} does not interrupt due to the projection tab 10a. The transfer fork T_{F} can fully access into the fork bar 10 to be positioned under of the cargo W.

The lifting carriage L_{C} of the stacker crane S_{C}, as shown in FIGS. 1 and 23, uprights along the mast M. The transfer fork T_{F} moves up simultaneously to load the cargo W thereon from the fork bar 10.

As shown in FIG. 24, the transfer fork T_{F} having the cargo W thereon retreats from the stand 1, and approaches the empty loading fork L_{F} of the rack R to load the cargo W on the loading fork L_{F}.

When in the unloading process of the cargo W, the above steps can be used in the reverse order. On issuing the unloading signal, the stacker S_{C} approaches the corresponding loading fork L_{F} and the cargo W is shifted on the transfer fork T_{F}. The transfer fork T_{F} moves to the stand 1 so as to move the cargo W on the stand 1.

The rollers 30 projected upright above each fork bar 10 of the stand 1 start the rotation in an unload direction by the motor 45, and the cargo W is transferred on the unloading conveyor C₂.

### INDUSTRIAL APPLICABILITY

As described above, according to the inventive loading and unloading stand for palletless storage system, cargo can approach the rack along on the conveyor, not on a pallet. The cargo is smoothly transferred on the stand installed in the rack. On the other hand, the cargo to be unloaded from the rack, smoothly moves to the conveyor after the cargo is transferred on the stand. Thus, even if no extra loading/unloading means, the transfer fork of the stacker crane can load/unload the cargo quickly and conveniently.

Therefore, the present invention has an advantage, in quick and precise loading or unloading of cargo into or from storage spaces, which can be accomplished and the operational reliability can be improved, considerably.

1. A loading and unloading stand of a palletless rack type storage system comprised of a plurality of racks having a loading fork and a stacker crane for loading cargo onto or unloading from the rack, and the stacker crane having a transfer fork arranged in a right angel to the loading fork, the transfer fork moving up or down in respect to the loading fork, the loading and unloading stand comprising:
plural fork bars arranged lengthwise with an interval to each other;
longitudinal beam arranged in a right angle against the fork bar, and supporting below the fork bar, so that at least one free end of the fork bar takes a form of cantilever, and fixedly mounting each fork bar on the rack;
plural rollers being arranged in a proper interval in the fork bar and the roller's rotation center arranged along a width of the fork bar, the upper portion of the roller having an excessive protrusion above the top of the fork bar so as to allow wheels of the cargo to be rolling-contacted; and
a drive unit to keep the rollers rolling in the loading or unloading direction of the cargo, in which the loading/unloading stand providing at a rim near the entrance of an predetermined floor of the rack and being a same level as the loading and unloading conveyor to load cargo into the rack from a loading station, or unload cargo to an unloading station from the rack.

2. The loading/unloading stand of a palletless rack type storage system according to claim 1, wherein: the fork bar has approximate U shape body, and plural support plates placed between each longitudinal wall of the body for rotationally supporting the roller.

3. The loading/unloading stand of a palletless rack type storage system according to claim 2, wherein: plural foreign substance outlets are formed at the floor of the fork bar.

4. The loading/unloading stand of a palletless rack type storage system according to claim 2, wherein: a cover is further provided on the top of the fork bar so as to prevent the entry of the foreign substance.

5. The loading/unloading stand of a palletless rack type storage system according to claim 2, wherein: plural foreign substance outlets are formed at the floor of the fork bar and a cover is provided on the top of the fork bar so as to prevent the entry of the foreign substance.

6. The loading/unloading stand of a palletless rack type storage system according to claim 1, wherein: an upper portion of a support hole formed at the support plate is left open, and the support hole supports a shaft of the roller.

7. The loading/unloading stand of a palletless rack type storage system according to claim 1, wherein: the fork bar is comprised of two parallel longitudinal walls and plural support plates placed at a right angle between each longitudinal wall for rotationally supporting the roller.

8. The loading/unloading stand of a palletless rack type storage system according to claim 1, wherein: the fork bar is a rectangular shape body, and a support plate is uprightly placed on the top plate of the body for supporting the roller.

9. The loading/unloading stand of a palletless rack type storage system according to claim 1, wherein: the fork bar is comprised of a rectangular body having a body opening at the top plate of the body, and a container-shape roller housing for accommodating the roller.

10. The loading/unloading stand of a palletless rack type storage system according to claim 1, wherein: the longitudinal beam is comprised of a first longitudinal beam for supporting one end of the fork bar and a second longitudinal beam for supporting middle portion of the fork bar, in which the transfer fork approaches toward only one lateral side of the stand.

11. The loading/unloading stand of a palletless rack type storage system according to claim 10, wherein: multiple rollers arranged at each fork bar at a regular interval form roller row, and neighboring shaft of each roller is drivingly coupled.

12. The loading/unloading stand of a palletless rack type storage system according to claim 11, wherein: a part of the rollers is arranged along a direction of loading/unloading of cargo in a certain interval, and is connected to the drive unit so it can rotate the roller, and the connected rollers act as driving rollers.

13. The loading/unloading stand of a palletless rack type storage system according to claim 1, wherein: each longitudinal beam support each end of the fork bar, where the respective supporting point is a distance from each end of the fork bar toward the middle of the fork bar, and the respective ends of each longitudinal beam are connected with a post, the transfer beam approaches both lateral sides of the stand, and the roller is comprised of a first roller and a second roller bordered at a center of the fork bar and being drivingly coupled, and the first roller is isolated from the second roller so as to individually support respective bottom of each cargo.

14. The loading/unloading stand of a palletless rack type storage system according to claim 13, wherein: the first and second roller is comprised of roller row having multiple rollers arranged at each fork bar at a regular interval, neighboring shaft of each roller is drivingly coupled.

15. The loading/unloading stand of a palletless rack type storage system according to claim 1, wherein: the drive unit is comprised of a drive pulley arranged in a predetermined interval below the fork bar having the roller row, a driven pulley provided at a shaft of the roller, a first drive belt coupling with neighboring drive pulley, a second drive belt connecting with the corresponding drive pulley and driven pulley, and a motor for giving rotation to one of any drive pulleys.

16. The loading/unloading stand of a palletless rack type storage system according to claim 1, wherein: a projection tab is provided at the lower middle portion of the fork bar with a proper height and is connected with each longitudinal beam.

17. The loading/unloading stand of a palletless rack type storage system according to claim 1, wherein: the stand is further comprised of a stopper that is comprised to stop the cargo running on the fork bar at a predetermined position.

18. The loading/unloading stand of a palletless rack type storage system according to claim 17, wherein: the stopper is a limit switch that is attached on a supporter between the cargo and the post and the supporter being uprighted from the longitudinal beam, by which the motor stops when the cargo has in contact with the limit switch.

19. The loading/unloading stand of a palletless rack type storage system according to claim 17, wherein: the stopper is a distance sensor that is attached on a post, by which the distance of the approaching cargo is detected to the drive unit.

20. The loading/unloading stand of a palletless rack type storage system according to claim 17, wherein: the stand is further comprised of a weight sensor that is installed at the lower portion of the longitudinal beam, by which the deflection of the longitudinal beam caused by the overweight cargo is measured, and a denial signal for overweight cargo is generated.
